(19) United States
(12) Patent Application Publication
(10) Pub. No.: US 2013/0155190 A1
(43) Pub. Date: Jun. 20, 2013

(54) DRIVING ASSISTANCE DEVICE AND METHOD

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/406,540

(22) Filed: Feb. 28, 2012

(30) Foreign Application Priority Data
Dec. 19, 2011 (CN) 201110427020.3

(51) Int. Cl. H04N 7/18; H04N 13/02

(52) U.S. Cl. 348/46; 348/E07.085; 348/E13.074

(57) ABSTRACT

An exemplary driving assistance method includes obtaining images of a surrounding environment of a vehicle captured by cameras mounted on the vehicle, each of the captured images comprising distance information indicating a distance between the corresponding camera and object captured by the corresponding camera. Next, the method includes extracting the distance information from the obtained captured images. The method then creates 3D models based on the extracted distance information, coordinates of each pixel of the at least one captured image and a reference point determined according to the captured images. Further, the method includes controlling display devices to display the created 3D models.

### BACKGROUND

1. Technical Field

The present disclosure relates to a driving assistance device capable of monitoring the surrounding environment of a vehicle such as an automobile, and to a related method.

2. Description of Related Art

To assist the driver of a running vehicle such as a motorcar to observe the surrounding environment, a video system is often installed in the vehicle. The video system usually employs cameras mounted on the sides and the rear portion of the vehicle to capture images at the sides and the rear of the vehicle, and a liquid crystal display (LCD) screen inside the vehicle to display the captured images. However, the image displayed on the display screen is a two-dimensional image, which may not clearly and accurately display the surrounding environment of the vehicle.

### BRIEF DESCRIPTION OF THE DRAWINGS

The components of any of the drawings are not necessarily drawn to scale, the emphasis instead being placed upon clearly illustrating the principles of the present driving assistance system and method.

FIG. 1 is a block diagram illustrating a driving assistance device in accordance with an exemplary embodiment, and showing the driving assistance device connected to a camera(s) and a display device.

FIG. 2 is a schematic, perspective diagram showing two of the cameras of FIG. 1 mounted on a side and a rear portion of a vehicle employing the driving assistance device.

FIG. 3 is a schematic diagram illustrating creating three-dimensional (3D) models of the surrounding environment of the vehicle of FIG. 2.

FIG. 4 is a flowchart of a driving assistance method in accordance with an exemplary embodiment.

### DETAILED DESCRIPTION

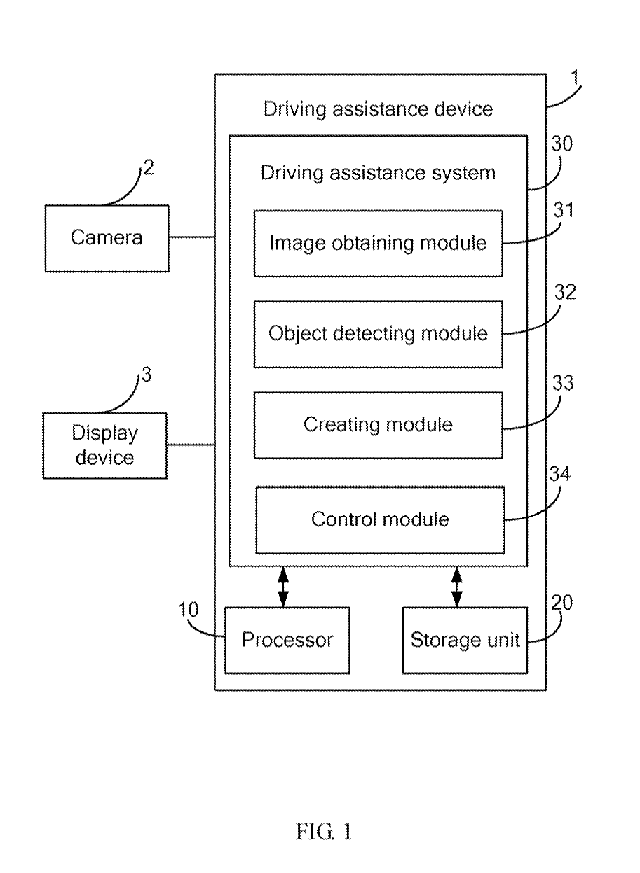

Referring to FIG. 1, this is a block diagram showing a driving assistance device 1. The driving assistance device 1 is connected to at least one camera 2, and to at least one display device 3. The driving assistance device 1 is installed on a vehicle such as an automobile. The driving assistance device 1 is used to create one or more three-dimensional (3D) model(s) according to one or more images captured by the at least one camera 2, and can display the created 3D model(s) on the at least one display device 3. The at least one display device 3 is located inside the vehicle for the driver of the vehicle to view.

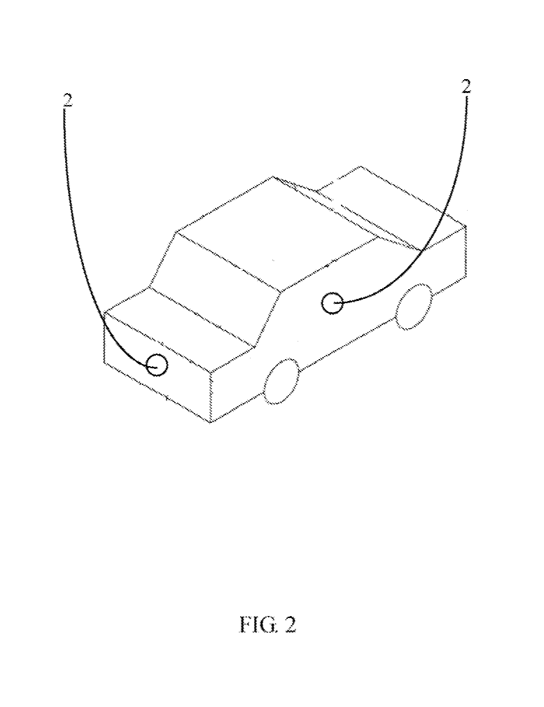

Each captured image includes a distance information component indicating the distance(s) between one camera 2 that captures the image and any one or more objects in the field of view of that camera 2. In the embodiment, each camera 2 is a TOF (Time of Flight) camera. Referring also to FIG. 2, in the embodiment illustrated and described below, three cameras 2 are taken as an example. The cameras 2 are respectively mounted on a left side, a right side, and a rear portion of the vehicle. It should be understood that the number and positions of the cameras 2 can be varied according to need. The cameras 2 can be controlled by the driving assistance device 1 to periodically capture images.

The driving assistance device 1 includes a processor 10, a storage unit 20, and a driving assistance system 30. In the embodiment, the driving assistance system 30 includes an image obtaining module 31, an object detecting module 32, a creating module 33, and a control module 34. One or more programs of the above-mentioned function modules 31, 32, 33, 34 may be stored in the storage unit 20 and executed by the processor 10. In general, the word “module,” as used herein, refers to logic embodied in hardware or firmware, or to a collection of software instructions, written in a programming language. The software instructions in the modules 31, 32, 33, 34 may be embedded in firmware, such as in an erasable programmable read-only memory (EPROM) device. The modules 31, 32, 33, 34 described herein may be implemented as either software and/or hardware modules, and may be stored in any type of computer-readable medium or other storage device.

The image obtaining module 31 is used to obtain the images of the surrounding environment of the vehicle taken by the three cameras 2.

The object detecting module 32 is used to extract the distance information in relation to the distance(s) between each of the cameras 2 and each of the objects appearing in the captured image of each camera 2. In the embodiment, the object detecting module 32 extracts the distance information using a Robust Real-time Object Detection Method which is well-known to one of ordinary skill in the art.

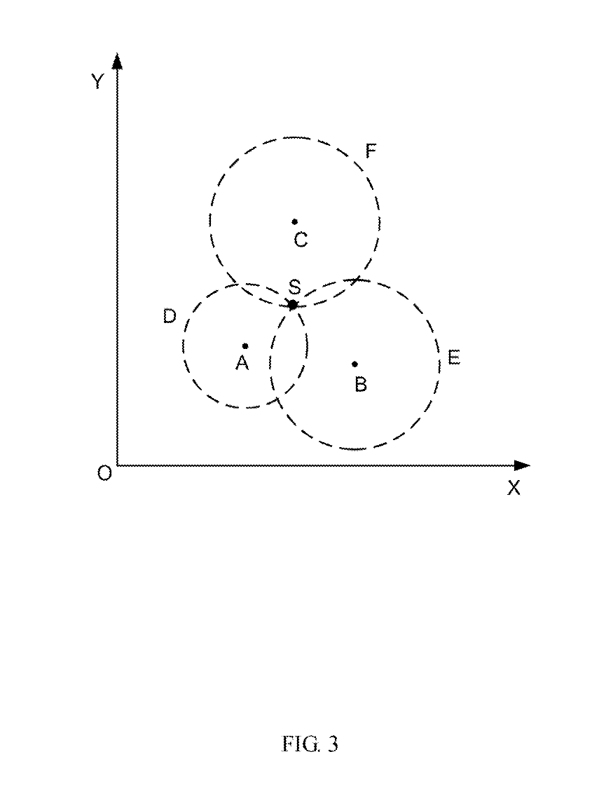

The creating module 33 is used to create 3D models of the surrounding environment based on the captured images and the extracted distance information. In detail, the creating module 33 establishes a Cartesian coordinate system in one image captured by each camera 2, and determines the coordinates of each pixel in the one image. The creating module 33 then randomly selects several pixels and creates several virtual spheres, with the positions of the selected pixels as center points of the virtual spheres and distance values of the selected pixels (obtained from the distance information) as radiuses of the virtual spheres. Because the selected pixels are at different positions, the creating module 33 further determines the intersection point of the virtual spheres, and the intersection point is referred to as a reference point. For example, as shown in FIG. 3, sphere D is created with the position of pixel A as its center point, sphere E is created with the position of pixel B as its center point, and sphere F is created with the position of pixel C as its center point. The spheres D, E and F intersect at point S. The creating module 33 further creates 3D models of the surrounding environment according to the coordinates of each pixel, the reference point, and the extracted distance information in the captured images.

In the embodiment, the 3D models respectively are named as a left side 3D model according to one image captured by the camera 2 mounted on the left side of the vehicle, a right side 3D model according to one image captured by the camera 2 mounted on the right side of the vehicle, and a rear portion 3D model according to one image captured by the camera 2 mounted on the rear portion of the vehicle.

In the embodiment, there is only one display device 3, and the control module 34 is used to control the display device 3 to display the three 3D models in a sub-frame mode. In an alternative embodiment, the control module 34 is used to control the display device 3 to display only one of the three 3D models at any one time, and to regularly and repeatedly switch the displaying of the 3D models in the following chronological order: the left side 3D model, the right side 3D model, and the rear portion 3D model. It should be understood that the chronological order of switching the displaying of the 3D models can be varied according to need. In another alternative embodiment, there can be three display devices 3, with each display device 3 corresponding to one camera 2. The control module 34 can control each display device 3 to constantly display one 3D model, which is created according to the image captured by the corresponding camera 2.

In the embodiment, the storage unit 20 stores a table recording the relationship between pixel value and distance range. Each distance range corresponds to one pixel value. The control module 34 is further used to determine the pixel value of each pixel in the image captured by the camera 2 according to the extracted distance information and the stored table, and assign the determined pixel value of the pixel to the corresponding pixel of the 3D model. The created 3D models can then be displayed in colors. Thus the driver can know the distance range between the vehicle and the object in the surrounding environment by noting the color of the object displayed on the display device 3. For example, when the distance between one object in the surrounding environment and the vehicle is about 110 meters (m), the control module 34 determines that the pixel value of the object is blue, and further assigns the pixel value of blue to the corresponding pixels of the 3D model. When the distance between one object in the surrounding environment and the vehicle is about 60 m, the control module 34 determines that the pixel value of the object is orange, and further assigns the pixel value of orange to the corresponding pixels of the 3D model.

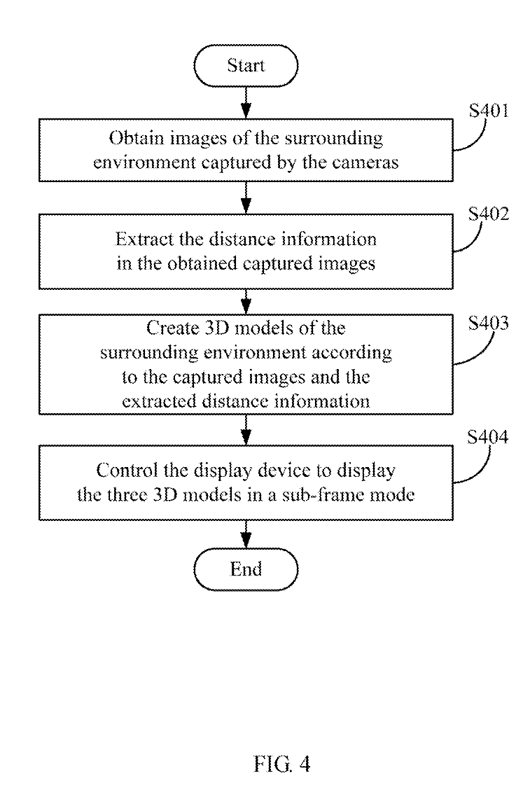

Referring to FIG. 4, a flowchart of a driving assistance method in accordance with an exemplary embodiment is shown.

In step S401, the image obtaining module 31 obtains the images of the surrounding environment of the vehicle taken by the three cameras 2.

In step S402, the object detecting module 32 extracts the distance information in relation to the distance(s) between each of the cameras 2 and each of the objects appearing in the captured image of each camera 2.

In step S403, the creating module 33 creates 3D models of the surrounding environment according to the captured images and the extracted distance information.

In step S404, the control module 34 controls the display device 3 to display the three 3D models in a sub-frame mode.

In an alternative embodiment, in step S404, the control model 34 controls the display device 3 to display only one of the three 3D models at any one time, and to regularly and repeatedly switch the displaying of the 3D models in the following chronological order: the left side 3D model, the right side 3D model, and the rear portion 3D model.

In another alternative embodiment, in step S404, there are three display devices 3. The control module 34 controls each of the three display devices 3 to constantly display one 3D model, which is created according to the image captured by the corresponding camera 2.

In the embodiment, the displaying of the 3D models is performed before the control module 34 assigns a pixel value(s) to the object(s) in the surrounding environment captured by the corresponding camera(s) 2.

In detail, for each 3D model, the control module 34 determines the pixel value of the pixels of each object captured by the corresponding camera 2 according to the extracted distance information and the stored table, and assigns the determined pixel value to the corresponding pixels of the 3D model.

Although the present disclosure has been specifically described on the basis of the exemplary embodiments thereof, the disclosure is not to be construed as being limited thereto. Various changes or modifications may be made to the embodiments without departing from the scope and spirit of the disclosure.

What is claimed is:

1. A driving assistance device comprising:
a storage unit;
a processor; and
one or more programs stored in the storage unit and executed by the processor, the one or more programs comprising:
an image obtaining module operable to obtain at least one image of a surrounding environment of a vehicle captured by at least one camera, each of the at least one captured image comprising distance information indicating at least one distance between the at least one camera and at least one object captured by the at least one camera;
an object detecting module operable to extract the distance information from the obtained at least one captured image;
a creating module operable to create at least one three-dimensional (3D) model based on the extracted distance information, coordinates of each pixel of the at least one captured image, and a reference point determined according to the at least one captured image; and
a control module operable to control at least one display device to display the created at least one 3D model.

2. The driving assistance device as described in claim 1, wherein the storage unit stores a table recording a relationship between pixel value and distance range, each of the distance ranges corresponds to one pixel value, and the control module is further operable to:
determine the pixel value of each of the pixels of the at least one captured image captured by the at least one camera according to the extracted distance information and the stored table; and
assign the determined pixel value to the corresponding pixel of the 3D model.

3. The driving assistance device as described in claim 1, wherein the at least one camera comprises three cameras, the cameras are mounted on a left side, a right side, and a rear portion of the vehicle, the at least one display device is one display device, the created at least one 3D model comprises three created 3D models, and the control module is further operable to control the display device to display the three 3D models in a sub-frame mode.

4. The driving assistance device as described in claim 1, wherein the at least one camera comprises three cameras, the cameras are mounted on a left side of the vehicle, a right side of the vehicle, and a rear portion of the vehicle, the at least one display device comprises three display devices, each of the display devices corresponds to one of the cameras, the created at least one 3D model comprises three created 3D models, and the control module is further operable to control each of the display devices to constantly display one of the 3D models which is created according to the image captured by the corresponding camera.

5. The driving assistance device as described in claim 1, wherein the at least one camera comprises three cameras, the cameras are mounted on a left side of the vehicle, a right side of the vehicle, and a rear portion of the vehicle, the at least one display device is one display device, the created at least one 3D model comprises three created 3D models, which are a left side 3D model created according to the image captured by the camera mounted on the left side of the vehicle, a right side 3D model created according to the image captured by the camera mounted on the right side of the vehicle, and a rear portion 3D model created according to the image captured by the camera mounted on the rear portion of the vehicle, and the control module is further operable to control the display device to display only one of the three 3D models at any one time, and to regularly and repeatedly switch the displaying of the three 3D models in a predetermined order.

6. The driving assistance device as described in claim 1, wherein when the creating module creates at least one 3D model based on the extracted distance information, the creating module establishes a Cartesian coordinate system in one image captured by each of the at least one camera, determines the coordinates of each pixel in a plurality of pixels of the one image, randomly selects a plurality of the plurality of pixels, creates a plurality of virtual spheres with the positions of the selected pixels as center points of the virtual spheres and distance values of the selected pixels obtained from the distance information as radiuses of the virtual spheres, determines the intersection point of the virtual spheres, and sets the intersection point as the reference point.

7. A driving assistance method comprising:
obtaining at least one image of a surrounding environment of a vehicle by capturing the at least one image with at least one camera, each of the at least one captured image comprising distance information indicating at least one distance between the at least one camera and at least one object captured by the at least one camera;
extracting the distance information from the obtained at least one captured image;
creating at least one three-dimensional (3D) model based on the extracted distance information, coordinates of each pixel of a plurality of pixels of the at least one captured image, and a reference point determined according to the at least one captured image; and
controlling at least one display device to display the created at least one 3D model.

8. The driving assistance method as described in claim 7, the storage unit storing a table recording a relationship between pixel value and distance range, each of the distance range corresponding to one pixel value, wherein the driving assistance method further comprises:
determining the pixel value of each of the pixels of the at least one captured image captured by the at least one camera according to the extracted distance information and the stored table; and
assigning the determined pixel value to the corresponding pixel of the 3D model.

9. The driving assistance method as described in claim 7, wherein the at least one camera comprises three cameras, the cameras are mounted on a left side, a right side, and a rear portion of the vehicle, the at least one display device is one display device, the created at least one 3D model comprises three created 3D models, wherein the driving assistance method further comprises:
controlling the display device to display the three 3D models in a sub-frame mode.

10. The driving assistance method as described in claim 7, the at least one camera comprises three cameras, the cameras are mounted on a left side of the vehicle, a right side of the vehicle, and a rear portion of the vehicle, the at least one display device comprises three display devices, each of the display devices corresponds to one of the cameras, the created at least one 3D model comprises three created 3D models, wherein the driving assistance method further comprises:
controlling each of the display devices to constantly display one of the 3D models which is created according to the image captured by the corresponding camera.

11. The driving assistance method as described in claim 7, the at least one camera comprises three cameras, the cameras are mounted on a left side of the vehicle, a right side of the vehicle, and a rear portion of the vehicle, the at least one display device is one display device, the created at least one 3D model comprises three created 3D models, which are a left side 3D model created according to the image captured by the camera mounted on the left side of the vehicle, a right side 3D model created according to the image captured by the camera mounted on the right side of the vehicle, a rear portion 3D model created according to the image captured by the camera mounted on the rear portion of the vehicle, wherein the driving assistance method further comprises:
controlling each of the display devices to display only one of the three 3D models at any one time, and to regularly and repeatedly switch the displaying of the three 3D models in a predetermined order.

12. The driving assistance method as described in claim 7, wherein the step of “creating 3D model(s) based on the extracted distance information, and coordinates of each pixel of the at least one captured image and a reference point determined according to the at least one captured image” further comprises:
establishing a Cartesian coordinate system in one image captured by each of the at least one camera, determines the coordinates of each pixel in a plurality of pixels of the one image;
selecting randomly a plurality of the plurality of pixels;
creating a plurality of virtual spheres with the position of the selected pixels as center points of the virtual spheres and distance values of the selected pixels obtained from the distance information as radiuses of the virtual spheres;
determining the intersection point of the virtual spheres;
setting the intersection point as the reference point; and
creating 3D model(s) based on the extracted distance information, and coordinates of each pixel of the at least one captured image and the reference point determined according to the at least one captured image.
